(19) United States
(12) Patent Application Publication
(10) Pub. No.: US 2009/0021084 A1
(43) Pub. Date: Jan. 22, 2009

(54) VOLTAGE ENHANCED BATTERY MODULE AND VOLTAGE ENHANCED BATTERY ASSEMBLY WITH THE SAME

(75) Inventor: Chun-Wei PAN, Lujhu Township (TW)

Correspondence Address: Muncy, Geissler, Olds & Lowe, PLLC, P.O. BOX 1364, FAIRFAX, VA, 22038-1364, US

(73) Assignee: Channel Well Technology Co., Ltd.

(21) Appl. No.: 12/108,297

(22) Filed: Apr. 23, 2008

(30) Foreign Application Priority Data
Jul. 20, 2007 (TW) 96211957

(51) Int. Cl. H02M 3/06

(52) U.S. Cl. 307/109

(57) ABSTRACT

A voltage enhanced battery module and a voltage enhanced battery assembly with the same are described. The voltage enhanced battery module includes a battery cell and a voltage enhancing circuit. The battery cell provides an original output voltage, and the voltage enhancing circuit generates a predetermined voltage difference with the power of the original output voltage to output an actual output voltage to a load. The predetermined voltage difference is superimposed on the original output voltage so that the actual output voltage equals the original output voltage plus the predetermined voltage difference. The battery cell is preferably a rechargeable Li—Fe battery cell. The voltage enhancing circuit can stop superimposing the predetermined voltage difference on the original output voltage when the original output voltage is lower than a predetermined value so that the actual output voltage equals the original output voltage. The voltage enhanced battery module is preferably used on a motor, a power tool such as a power screwdriver or drill, or an electric motorcycle.

### RELATED APPLICATIONS

The present application is based on, and claims priority from, Taiwan Application Serial Number 96211957, filed Jul. 20, 2007, which is herein incorporated by reference.

### FIELD OF THE INVENTION

The present invention generally relates to an electric module to enhance a battery output voltage. More particularly, this invention relates an electric module to enhance a battery output voltage of a rechargeable Li—Fe battery.

### BACKGROUND OF THE INVENTION

Since technology and industry are highly developed, electronic and electric equipments are becoming increasingly light, and easy to hold. Some electric equipment and motors are increasingly driven by batteries to replace the conventional electric equipments and motors driven by the alternating current because the battery technology is extremely developed recently. For example, the conventional power tools, such as the power screwdriver and the power drill, driven by the alternating current are replaced by the power tools driven by batteries. In addition, some of the conventional motorcycles and cars driven by an engine are also increasingly replaced by the motorcycles and cars with the electric motors supplied by the battery.

However, due to the material restrictions, the output voltage and the output current of the battery are limited. A rechargeable Li—Fe battery can provide a higher current output with the stable capacity, high safety performance and excellent rechargeable performance. The rechargeable Li—Fe battery is suitable to apply to a power tool, an uninterruptible power supply (UPS), a hybrid electric vehicle, a power bike, a power wheelchair, an electric scooter or a remote control aircraft. Especially, the rechargeable Li—Fe battery is preferable to drive the motor having the inductive load.

Due to the limitations of the chemical reaction property of the battery, in general, single battery cell cannot provide enough power to drive the motor. Currently, a voltage enhancing circuit can be attached to the battery cell to raise the output voltage to a higher fixed output voltage of the battery cell.

Refer to FIG. 1. FIG. 1 illustrates an output voltage curve for a conventional battery with the voltage enhancing circuit. Curve 110 represents the original output voltage of the battery cell. Curve 110 decays along the operating time of the battery. A conventional voltage enhancing circuit can raise the original output voltage from about 3.4V to about 4.2 V, referring to curve 120. However, due to the original output voltage of the battery decays with the operating time thereof, the curve 120 may sharply drop down at the position 130. In position 130, the original output voltage of the battery is not enough to provide a required power for the voltage enhancing circuit. Therefore, the battery cannot continuously drive a motor after the position 130.

Accordingly, there is a need to provide a new voltage enhancing circuit for the battery to extend the operating life of the battery.

### SUMMARY OF THE INVENTION

It is an objective of the present invention to provide a voltage enhancing circuit superimposing a predetermined voltage on an original output voltage of a battery so as to increase the actual output voltage for the battery.

It is another objective of the present invention to provide a voltage enhancing circuit superimposing a predetermined voltage on an original output voltage of a battery and to stop superimposing on the original output voltage when the original output voltage is lower than a critical value to further extend the operating life of the battery.

To accomplish the above objectives, the present invention provides a voltage enhanced battery module for a motor, a power tool, e.g. a power screwdriver or a power drill, or an electric motorcycle. The voltage enhanced battery module includes a battery cell having a positive electrode and a negative electrode to provide an original output voltage and the voltage enhancing circuit connected to the positive electrode of the battery cell. The voltage enhancing circuit generates a predetermined voltage difference with the energy of the battery cell to superimpose on the original output voltage so as to output an actual output voltage to a load, for example, the motor, the power tool or the electric motorcycle.

The battery cell is preferably a rechargeable Li—Fe battery cell. The voltage enhancing circuit utilizes a processing circuit to connect to the positive electrode of the battery cell and the processing circuit stops superimposing the predetermined voltage difference on the original output voltage so as to provide the actual output voltage, equal to the original output voltage, for the load when the original output voltage is lower than a predetermined value. The predetermined value is preferably about 3.9 V.

The voltage enhancing circuit includes a first capacitor and a second capacitor. One end of the first capacitor is connected to the processing circuit and the another end is connected to the positive electrode of the battery cell. In addition, one end of the second capacitor is connected to the positive electrode of the battery cell and another end is connected to a ground. The voltage enhancing circuit further includes a diode disposed between the output terminal of the voltage enhancing circuit and the processing circuit. The voltage enhancing circuit preferably includes an inductor disposed between the positive electrode of the battery cell and the processing circuit.

Furthermore, the voltage enhanced battery module preferably includes a recharge circuit to recharge the battery cell. The recharge circuit further preferably includes a diode.

Therefore, the voltage enhanced battery module with the voltage enhancing circuit according to the present invention can be quickly recharged by a large recharging current. The voltage enhanced battery module can supply a large current to the electric load. The voltage enhanced battery module can further extend the operating time for every time recharge and increase the output voltage thereof so that the total cost of ownership (TCO) of the power tool with the voltage enhanced battery module with the voltage enhancing circuit according to the present invention can be reduced.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 illustrates a battery output voltage curve for a battery cell with a conventional voltage enhancing circuit;

FIG. 2 illustrates a battery output voltage curve for a battery cell with a voltage enhancing circuit according to the present invention;

FIG. 3A illustrates a preferred embodiment of a battery cell with a voltage enhancing circuit according to the present invention;

FIG. 3B illustrates another preferred embodiment of a battery cell with a voltage enhancing circuit according to the present invention; and

FIG. 4 illustrates a preferred embodiment of a voltage enhanced battery assembly with a voltage enhancing circuit according to the present invention.

### DETAILED DESCRIPTION OF THE PREFERRED EMBODIMENT

The following description is currently the best implementation of the present invention. This description is not to be taken in a limiting sense but is made merely to describe the general principles of the invention. The scope of the invention should be determined by referencing the appended claims.

Refer to FIG. 2. FIG. 2 illustrates a battery output voltage curve for a battery cell with a voltage enhancing circuit according to the present invention. Curve 220 represents an actual output voltage of the battery cell with the voltage enhancing circuit according to the present invention. Curve 210 represents an original output voltage of the battery cell with the voltage enhancing circuit according to the present invention. The voltage enhancing circuit adds a predetermined voltage difference on the original output voltage of the battery cell to increase the actual output voltage of the battery cell. In addition, the actual output voltage decays with the operating time of the battery rather than maintains at a fixed voltage.

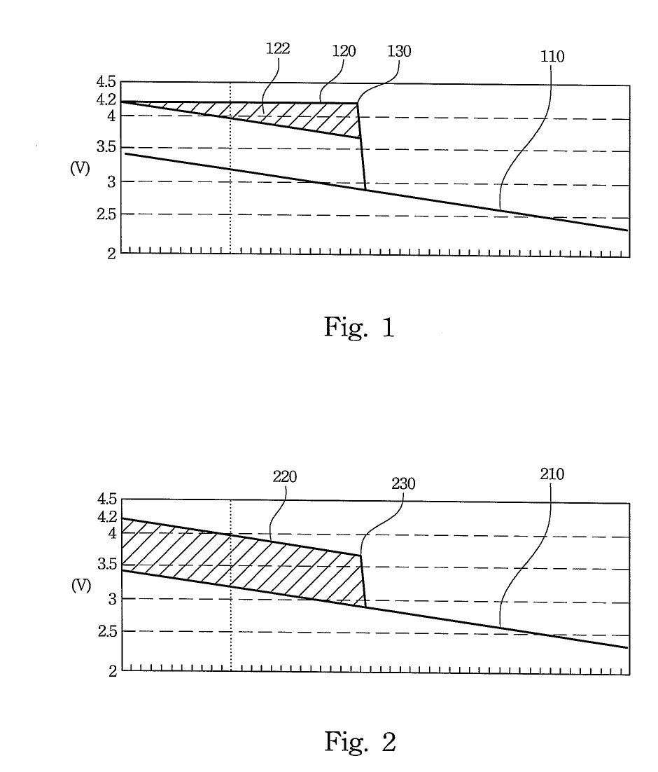

Compared FIG. 1 with FIG. 2, the conventional voltage enhancing circuit maintains a fixed output voltage and the voltage enhancing circuit according to the present invention adds a predetermined voltage difference on the original output voltage. Therefore, referring to a block 122 of FIG. 1, the conventional voltage enhancing circuit spends more energy for maintaining the fixed output voltage.

For maintaining a fixed output voltage, the battery cell with the conventional voltage enhancing circuit is exhausted much earlier than the battery cell with the voltage enhancing circuit according to the present invention. The battery cell with the voltage enhancing circuit according to the present invention provides a variable output voltage to an electric equipment. The output voltage of the battery cell according to the present invention is reduced following the original output voltage. Especially, when the original output voltage of the battery according to the present invention is reduced to a predetermined value, the voltage enhancing circuit then stops superimposing the predetermined voltage difference on the original output voltage. Therefore, the residue energy of the battery cell can continue to use for the electric equipment. On the contrary, the battery cell with the conventional voltage enhancing circuit cannot provide enough energy for the conventional voltage enhancing circuit. The output voltage of the conventional battery cell is therefore rippled so that the conventional battery cell cannot provide enough output voltage for the electric equipment. Therefore, the operable time of the conventional battery cell is reduced.

The voltage enhancing circuit according to the present invention can stop superimposing the predetermined voltage difference on the original output voltage, when the original output voltage of the battery according to the present invention is reduced to a predetermined voltage. Alternatively, the voltage enhancing circuit according to the present invention may stop superimposing the predetermined voltage difference on the original output voltage when the output voltage of the battery cell according to the present invention reaches the position 230. Therefore, the actual output voltage of the battery cell is the same as the original output voltage of the actual output voltage to further use the residual energy of the battery cell without ripples. For example, when an output voltage of a rechargeable Li—Fe battery cell is equal to about 2.9V, the voltage enhancing circuit according to the present invention stops superimposing the predetermined voltage difference on the original output voltage. This prevents the output voltage from rippling so as to further use the residual energy of the Li—Fe battery cell.

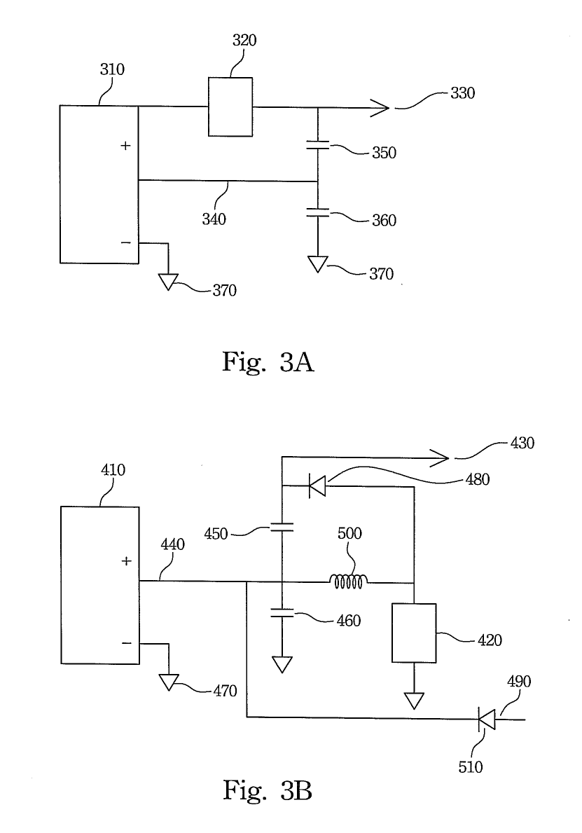

Refer to FIG. 3A. FIG. 3A illustrates a preferred embodiment of a battery cell with a voltage enhancing circuit according to the present invention. A positive electrode of a rechargeable Li—Fe battery cell 310 is connected to a processing circuit 320 to provide an original output voltage. A capacitor 350 is disposed between another end of the processing circuit 320 and an original output circuit 340, also referred to as the positive electrode of the rechargeable Li—Fe battery cell 310. A capacitor 360 is disposed between the original output circuit 340 and a ground terminal 370, also referred to as the negative electrode of the Li—Fe battery cell 310. Therefore, through the processing circuit 320 and the capacitor 350, the battery cell 310 can add a predetermined voltage difference on the original output voltage to increase actual output voltage of the rechargeable Li—Fe battery cell 310. In addition, the actual output voltage of the rechargeable Li—Fe battery cell 310 is therefore equal to the original output voltage of the rechargeable Li—Fe battery cell 310 plus the voltage difference generated by the processing circuit 320

When the original output voltage reduces to a predetermined voltage, the processing circuit 320 shuts down the superimposing function thereof to allow the actual output voltage of the Li—Fe battery cell 310 equal to the original output voltage thereof so as to prevent the output voltage from rippling and further use the residual energy of the Li—Fe battery cell 310. Therefore, the operating time of the rechargeable Li—Fe battery cell 310 can be extended.

Refer to FIG. 3B. FIG. 3B illustrates another preferred embodiment of a battery cell with a voltage enhancing circuit according to the present invention. A positive electrode of a rechargeable Li—Fe battery cell 410 is connected to an original output circuit 440 to provide an original output voltage. The original output circuit 440 is connected the processing circuit 420 through an inductor 500. One end of the processing circuit 420 is a ground terminal 470, also referred to as the native electrode of the rechargeable Li—Fe battery cell 410. Another end of the processing circuit 420 is connected to the output circuit 430 through a diode 480. In addition, the original output circuit 440 is connected to the output circuit 430 through the capacitor 450. The original output circuit 440 is also connected to the negative electrode of the rechargeable Li—Fe battery cell 410 through the capacitor 460. In the same manner, with the processing circuit 420, the actual output voltage outputted from the output circuit 430 is equal to the original output voltage plus the predetermined voltage difference so as to increase the actual output voltage of the rechargeable Li—Fe battery cell 410. When the original output voltage of the original output circuit 440 is lower than a predetermined value, the processing circuit 420 shuts down the superimposing function thereof to directly use the original output voltage of the Li—Fe battery cell 410 to drive the electric load so as to completely use the residual energy of the Li—Fe battery cell 410.

Furthermore, this preferred embodiment further includes a recharge circuit 490 to directly connect to the original output circuit 440 to recharge the rechargeable Li—Fe battery cell 410 with external power source. The recharge circuit 490 preferably includes a diode 510 to prevent a reverse electric current. The recharge circuit 490 can provide a large recharging current to quickly recharge the rechargeable Li—Fe battery cell 410 in a short time. The recharge circuit 490 can be also connected to a generator of an electric motorcycle to store the renewable energy in the rechargeable Li—Fe battery cell 410. The recharge circuit 490 can also be electrically connected to an external circuit to directly drive the electric load equipped with the rechargeable Li—Fe battery cell 410.

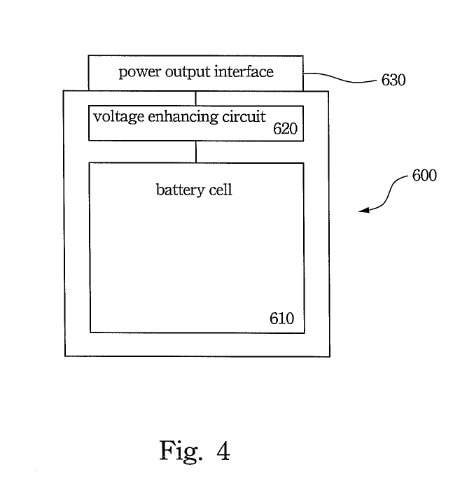

Refer to FIG. 4. FIG. 4 illustrates a preferred embodiment of a voltage enhanced battery assembly with a voltage enhancing circuit according to the present invention. The voltage enhanced battery assembly 600 includes a battery cell 610, a voltage enhancing circuit 620 and a power output interface 630. The battery cell 610 can be a single battery cell or a plurality of battery cells connected in parallel or series. The battery cell 610 is preferably a rechargeable Li—Fe battery cell. The voltage enhanced battery assembly 600 uses the voltage enhancing circuit 620 to increase the output voltage thereof and transmits the output voltage to electric equipment through the power output interface 630. The voltage enhanced battery assembly 600 can be formed similar to an exterior of a regular battery and compatible with the regular battery so as to easily replace the regular battery.

Since the rechargeable Li—Fe battery cell can be quickly recharged and provide large output current to the electric equipment, in combination with the voltage enhancing circuit according to the present invention, the voltage enhanced battery module and the voltage enhanced battery assembly can provide a suitable output voltage to the electric equipment and extend the operating time for the electric equipment. Accordingly, the total cost of ownership of the electric equipment, especially for the power tool, is effectively reduced.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A voltage enhanced battery module, comprising:
a battery cell having a positive electrode and a negative electrode to provide an original output voltage; and
a voltage enhancing circuit having an output terminal, the voltage enhancing circuit connected to the positive electrode of the battery cell and generating a predetermined voltage difference with the energy of the battery cell to superimpose on the original output voltage so as to output an actual output voltage to a load through the output terminal.

2. The voltage enhanced battery module of claim 1, wherein the battery cell comprises a Li—Fe battery cell.

3. The voltage enhanced battery module of claim 2, wherein the Li—Fe battery cell is rechargeable.

4. The voltage enhanced battery module of claim 3, wherein the voltage enhancing circuit comprises a processing circuit connected to the positive electrode of the battery cell and the processing circuit stops superimposing the predetermined voltage difference on the original output voltage to provide the actual output voltage, equal to the original output voltage, for the load when the original output voltage is lower than a predetermined value.

5. The voltage enhanced battery module of claim 4, wherein the predetermined value is about 3.9 V.

6. The voltage enhanced battery module of claim 4, wherein the voltage enhancing circuit further comprises:
a first capacitor, one end of the first capacitor connected to the processing circuit and another end of the first capacitor connected to the positive electrode of the battery cell; and
a second capacitor, one end of the second capacitor connected to the positive electrode of the battery cell and another end of the second capacitor connected to a ground.

7. The voltage enhanced battery module of claim 6, wherein the voltage enhancing circuit further comprises:
a diode disposed between the output terminal of the voltage enhancing circuit and the processing circuit.

8. The voltage enhanced battery module of claim 7, wherein the voltage enhancing circuit further comprises:
an inductor disposed between the positive electrode of the battery cell and the processing circuit.

9. The voltage enhanced battery module of claim 1, further comprising:
a recharge circuit connected to the positive electrode of the battery cell to recharge the battery cell.

10. The voltage enhanced battery module of claim 9, wherein the recharge circuit further comprises a diode.

11. The voltage enhanced battery module of claim 1, wherein the load is a motor, a power tool or an electric motorcycle.

12. A voltage enhanced battery module, comprising:
a Li—Fe battery cell having a positive electrode and a negative electrode to provide an original output voltage; and
a voltage enhancing circuit connected to the positive electrode of the Li—Fe battery cell and generating a predetermined voltage difference with the energy of the Li—Fe battery cell to superimpose on the original output voltage, the voltage enhancing circuit further comprising:
an output terminal to output an actual output voltage to a load;
a processing circuit connected to the positive electrode of the Li—Fe battery cell, wherein the processing circuit stops superimposing the predetermined voltage difference on the original output voltage to provide the actual output voltage, equal to the original output voltage, for the load when the original output voltage is lower than a predetermined value;
a first capacitor, one end of the first capacitor connected to the processing circuit and another end of the first capacitor connected to the positive electrode of the Li—Fe battery cell; and
a second capacitor, one end of the second capacitor connected to the positive electrode of the Li—Fe battery cell and another end of the second capacitor connected to a ground.

13. The voltage enhanced battery module of claim 12, wherein the Li—Fe battery cell is rechargeable.

14. The voltage enhanced battery module of claim 12, wherein the predetermined value is about 3.9 V.

15. The voltage enhanced battery module of claim 12, further comprising:
a recharge circuit connected to the positive electrode of the Li—Fe battery cell to recharge the rechargeable Li—Fe battery cell.

16. A voltage enhanced battery assembly, comprising:
a power output interface;
a battery cell providing an original output voltage; and
a voltage enhancing circuit disposed between the power output interface and the battery cell, the voltage enhancing circuit generating a predetermined voltage difference with the energy of the battery cell to superimpose on the original output voltage to supply an actual output voltage for a load.

17. The voltage enhanced battery assembly of claim 16, wherein the battery cell comprises an Li—Fe battery cell.

18. The voltage enhanced battery assembly of claim 17, wherein the Li—Fe battery cell is rechargeable.

19. The voltage enhanced battery assembly of claim 16, wherein the load is a motor, a power tool or an electric motorcycle.

20. The voltage enhanced battery assembly of claim 16, wherein the voltage enhancing circuit comprises a processing circuit connected to the battery cell and the processing circuit stops superimposing the predetermined voltage difference on the original output voltage so that the actual output voltage is equal to the original output voltage.
